(19) United States
(12) Patent Application Publication
(10) Pub. No.: US 2017/0367383 A1
(43) Pub. Date: Dec. 28, 2017

(54) PROCESS FOR ENHANCING MUSCLE PORTIONS AND PRODUCTS

(71) Applicant: CARGILL, INCORPORATED, Wayzata, MN (US)

(72) Inventors: Oscar ESQUIVEL, Wichita, KS (US); Lasika SHYAMALIE SENARATNE-LENAGAL, Wichita, KS (US)

(21) Appl. No.: 15/536,016

(22) PCT Filed: Dec. 15, 2015
(86) PCT No.: PCT/US15/65747

§ 371 Date: Jun. 14, 2017

Related U.S. Application Data
(60) Provisional application No. 62/091,877, filed on Dec. 15, 2014.

(51) Int. Cl. A23L 13/60; A23L 13/40

(52) U.S. Cl. CPC A23L 13/60; A23L 13/42; A23L 13/432; A23V 2002/00

(57) ABSTRACT

Animal muscle portions are treated to form an enhanced muscle portion by providing a comminuted meat emulsion made from a first animal muscle tissue and having a pH of from about 6.5 to about 9.5, and adding the emulsion to an animal muscle portion in a manner that promotes uptake and/or distribution of the emulsion into the animal muscle portion to form an enhanced muscle portion. In an aspect, at least about 70% by weight of the protein of the tissue in the emulsion is solubilized, and the protein is not isolated from the tissue. In an aspect, no more than about 30% by weight of the protein of the tissue is precipitated. In an aspect, the tissue is not exposed to acid in a manner that would cause the pH of the tissue to be less than about 5.3. Products prepared by the processes are also described.

### CROSS-REFERENCE TO RELATED APPLICATIONS

This application claims the benefit of U.S. Provisional Application Ser. No. 62/091,877, filed Dec. 15, 2014, entitled “PROCESS FOR ENHANCING MUSCLE PORTIONS AND PRODUCTS” which application is incorporated herein by reference in its entirety.

### FIELD

The present invention relates to treatment of meats. More specifically, the present invention relates to enhancing muscle portions.

### BACKGROUND

Meat is a high value food source. Efforts have long been expended to improve the flavor, consistency and water retention properties of meat, including addition of materials by marinating or injection.

Examples of efforts to enhance meat include dispersion of brine mixtures including gelatin, water and optional additives into meats, as is described in PCT applications WO07070686A1, WO07047525A2, and WO07109060A2.

Another meat enhancement approach is to inject a cold particle suspension into a meat portion as described in U.S. Pat. No. 4,960,599 to Cozzini et. al.

Protein suspensions comprising sarcoplasmic proteins and myofibrillar proteins derived from animal muscle tissue have been asserted to provide improved moisture retention in food being thawed or cooked. See US Patent Application Publication No. 2011/0244093 to Kelleher et al. This application describes obtaining animal muscle protein compositions from animal muscle tissue by comminuting the animal muscle tissue and then mixing it with a food grade alkaline composition under conditions to solubilize the animal muscle protein thereby forming a solution of animal muscle protein. The solubilized basic animal muscle tissue then is mixed with a food grade acid composition to decrease the pH of the solubilized animal muscle protein to a pH between about 4.7 and about 11.0, preferably between about pH 5.5 and about 9.5, thereby to precipitate the protein. The precipitated protein then is comminuted to form protein particulates suspended in an aqueous medium. The thus prepared composition invention is added to a food to be thawed and/or cooked to increased moisture retention in the food. See paragraph [0010]. The pH of the solution for solubilizing the protein is disclosed to be about 10.5 or greater. See paragraph [0015].

A process for isolating proteins is described in U.S. Pat. No. 6,136,959 to Hultin et al., wherein protein is treated with base, centrifuged and acidified to precipitate the edible protein. See column 1, lines 24-35. The pH of the solution after treatment with base is disclosed to be greater than about 10.0. See column 3, lines 25-28. U.S. Pat. No. 7,556,835 likewise discloses a process for isolating proteins by solubilizing the protein in alkaline solution and precipitating the solubilized protein from the mixture. See column 1, lines 58-67. The solubilization of the protein is disclosed to be accomplished by increasing the pH of the mixture to about 10.0 or above. See column 2, lines 47-50.

A process for improving water holding capacity and tenderness in cooked protein food products is described US Patent Application Publication No. 2010/0009048 to Hultin et al (“Hultin '048”). As discussed in paragraph [0017] of Hultin '048, the food product to be treated with a pH adjusting solution is so treated by injecting with the solution, tumbling the food with the solution or soaking the food product with the solution. Thus, the food product to be treated are portions (including minced portions), and is not a comminuted meat emulsion that itself is then added to an animal muscle portion. Hultin '048 discloses incorporation of protein isolates in the pH adjusting solution. See, e.g., Paragraphs [0014] and [0015]. Hultin '048 clarifies that “[m]ethods for preparing proteins and protein isolates are known in the art and can be found, e.g., in U.S. Pat. Nos. 6,005,073, 6,136,959, 6,288,216, and 6,451,975,” See paragraph [0050]. All of these referenced patents discuss isolating the protein from the animal muscle.

### SUMMARY

It has been found that animal muscle portions can be advantageously treated by a comminuted meat emulsion having a pH of from about 6.5 to about 9.

In the present method, animal muscle portions are treated to form an enhanced muscle portion by a process comprising providing a comminuted meat emulsion having a pH of from about 6.5 to about 9, the comminuted meat emulsion being prepared from a first animal muscle tissue; and adding the comminuted meat emulsion to an animal muscle portion in a manner that promotes uptake and/or distribution of the comminuted meat emulsion into the animal muscle portion to form an enhanced muscle portion. In an aspect, at least about 70% by weight of the protein of the first animal muscle tissue in the comminuted meat emulsion is solubilized, and the protein of the first animal muscle tissue in the comminuted meat emulsion is not isolated from the first animal muscle tissue in the comminuted meat emulsion. In an aspect, no more than about 30% by weight of the protein of the first animal muscle tissue in the comminuted meat emulsion is precipitated. In an aspect, the first animal muscle tissue is not exposed to acid in a manner that would cause the pH of the first animal muscle tissue to be less than about 5.3.

Final enhanced muscle portion products prepared by this process may exhibit superior performance related to one or more of the following properties: yield, structural integrity (e.g. demonstrated by better cohesive behavior when sliced), easier slicing, less purge of the comminuted meat emulsion before and/or after cooking, less sticking of encased meats to the casing, superior color, and superior product appearance when cooked.

While not being bound by theory, it is believed that exposing comminuted animal muscle tissue to pH in the range of from about 6.5 to about 9.5 prior to adding the emulsion to a meat portion creates greater net charges on proteins in the muscle tissue, and increases the amount of bound and immobilized water. In contrast, comminuted animal muscle tissue that is exposed to lower pH will exhibit overall reduction of reactive groups on proteins available for water binding, particularly if the protein is denatured or rendered insoluble in water. Additionally, it is believed that higher net charge differences on proteins that have been exposed to pH of from about 6.5 to about 9.5 causes these proteins to exhibit an increase in the repulsion between myofibrils of the protein, thereby creating space between muscle fibers of the muscle tissue to be treated. This increase in space promotes retention of water.

In addition to the benefit of higher water retention, exposure of the comminuted animal muscle tissue to only the indicated pH ranges described herein provides distinct organoleptic properties in the final product. It has been found that exposure of meat to pH ranges lower than 5.3 and higher than about 9.5 leads to denaturing of the proteins in the meat. It has been found that denaturing the protein reduces effectiveness of the ability for the emulsion to retain water in the meat. It has additionally been found that denaturing the protein irreversibly lowers the viscosity of the final emulsion, requiring thickeners to be added in order to increase the viscosity again. If the comminuted animal muscle tissue is exposed to a pH that is too low, the color of the meat tends to fade to an undesirable level. If the comminuted animal muscle tissue is exposed to a pH that is too high, the color of the meat tends to darken to an undesirably dark color.

The present process advantageously is a simple process requiring fewer steps, and uses fewer and a lower quantity of ingredients than other processes involving acid treatment of meat followed by exposure to alkaline pH compositions. This is because the present process does not use acid in the levels of other processes, and additionally uses less alkali to balance out the acid of such meat pretreatment. The present process requires only the use of simple processing equipment, and is easy to carry out.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

The accompanying drawings, which are incorporated in and constitute a part of this application, illustrate several aspects of the invention and together with a description of the aspects serve to explain the principles of the invention. A brief description of the drawings is as follows:

FIG. 1 is a photograph showing a sample of a prior art comminuted meat emulsion that is Control A from the examples.

FIG. 2 is a photograph showing a sample of a comminuted meat emulsion that is Test Composition 1 from the examples.

FIG. 3 is a photograph showing a sample of a comminuted meat emulsion that is Test Composition 2 from the examples.

FIG. 4 is a photograph showing a sample of a comminuted meat emulsion that is Test Composition 3 from the examples.

### DETAILED DESCRIPTION

The aspects of the present invention described below are not intended to be exhaustive or to limit the invention to the precise forms disclosed in the following detailed description. Rather a purpose of the aspects chosen and described is so that the appreciation and understanding by others skilled in the art of the principles and practices of the present invention can be facilitated.

The animal muscle portion to be treated in accordance with the present invention may be any variety of meat from any species. Suitable meats include those obtained from bovine, porcine, equine, caprine, ovine, avian animals, or any animal commonly slaughtered for food production. Bovine animals may include, but are not limited to, buffalo, and all cattle, including steers, heifers, cows, and bulls. Porcine animals may include, but are not limited to, feeder pigs and breeding pigs, including sows, gilts, barrows, and boars. Ovine animals may include, but are not limited to, sheep, including ewes, rams, wethers, and lambs. Poultry may include, but are not limited to, chicken, turkey, and ostrich. In a preferred aspect, the animal muscle portion to be treated is beef, pork, turkey or chicken.

The animal muscle portion may be provided in any suitable cut or portion, including whole carcasses (especially poultry), primals (hams), sub-primals, steaks, and irregular cuts. In a particularly preferred aspect, the animal muscle portion is provided in a cut steak portion. In an aspect, the animal muscle portion is in the form of intact muscle tissue portions of at least 1 oz (28 g), or in muscle tissue portions of at least 3 oz (85 g), or in muscle tissue portions of from about 1 oz (28 g) to about 3 lbs (1.4 kg), or in muscle tissue portions of from about 3 oz (85 g) to about 2 lbs (0.9 kg).

In an aspect, the animal muscle portion is in the form of ground meat. In an aspect, the final enhanced muscle portion in the form of an encased meat such as a sausage. In an aspect, the final enhanced muscle portion in the form of an encased meat that is a combination of a plurality of whole muscle meat portions provided as a slicing log. In an aspect, the slicing log is a combination of a plurality of whole muscle meat portions and ground meat. In an aspect, the slicing log is a combination of a ground meat portions. The slicing logs are cooked prior to slicing.

In the present process, a comminuted meat emulsion is prepared from a first animal muscle tissue that is sourced from any variety of meat from any species. Suitable meats include those obtained from bovine, porcine, equine, caprine, ovine, avian animals, or any animal commonly slaughtered for food production. Bovine animals may include, but are not limited to, buffalo, and all cattle, including steers, heifers, cows, and bulls. Porcine animals may include, but are not limited to, feeder pigs and breeding pigs, including sows, gilts, barrows, and boars. Ovine animals may include, but are not limited to, sheep, including ewes, rams, wethers, and lambs. Poultry may include, hut are not limited to, chicken, turkey, and ostrich. Mixtures of such meat sources are also contemplated.

In an aspect, the first animal muscle tissue of the comminuted meat emulsion is sourced from the same animal species as the animal muscle portion to be treated. This aspect is particularly preferred because flavor and ingredient consistency is maximized.

In an aspect, the first animal muscle tissue of the comminuted meat emulsion is at least about 50% lean, or at least about 60% lean, or at least about 70% lean, or at least about 80% lean, or at least about 85% lean, or at least about 90% lean, or at least about 95% lean.

In an aspect, the first animal muscle tissue of the comminuted meat emulsion comprises myofibrillar protein that is at least about 50 wt % of the protein content of the comminuted animal muscle tissue. In an aspect, the first animal muscle tissue of the comminuted meat emulsion comprises myofibrillar protein that is from about 55 to about 98 wt % of the protein content of the meat of the comminuted meat emulsion. In an aspect, the first animal muscle tissue of the comminuted meat emulsion comprises myofibrillar protein that is from about 70 to about 90 wt % of the protein content of the meat of the comminuted meat emulsion. This aspect is particularly useful for a final product meat that is cooked prior to delivery to the customer.

In an aspect, the myofibrillar protein is at least about 1.5 wt % of the comminuted meat emulsion. In an aspect, the myofibrillar protein is from about 1.5 wt % to about 25 wt % of the comminuted meat emulsion. In an aspect, the myofibrillar protein is at least from about 1.5 wt % to about 10 wt % of the comminuted meat emulsion. It has been found that prior systems are limited in the amount of myofibrillar protein that can be present in compositions to be injected in meat. It has surprisingly been found that by the present process of preparing emulsions under alkaline conditions as described herein, and preferably incorporating salt, a high myofibrillar protein content can be achieved in comminuted meat emulsions for incorporation into animal muscle portions. In an aspect, the myofibrillar protein is at least about 2 wt %, preferably at least about 2.5 wt %, and more preferably at least about 3 wt % of the comminuted meat emulsion. In an aspect, the myofibrillar protein is from about 2 wt % to about 10 wt %, preferably from about 2.5 wt % to about 10 wt %, and more preferably from about 3 wt % to about 10 wt % of the comminuted meat emulsion.

In an aspect, the first animal muscle tissue of the comminuted meat emulsion is comminuted by chopping, grinding, or flaking prior to emulsification according to well-known procedures. In an aspect, the first animal muscle tissue is comminuted into fine particles by apparatus having one or more rotating blades or one or more reciprocating blades.

In an aspect, the first animal muscle tissue is provided in portion size without being comminuted; and is mixed with the food grade alkaline composition. After formation of this mixture, the first animal muscle tissue is then comminuted to the desired end particle size in one or more comminution steps to form a comminuted meat emulsion having a of from about 6.5 to about 9.5.

In an aspect, the first animal muscle tissue is comminuted to form a comminuted animal muscle tissue having an intermediate particle size that is larger than the desired end particle size, which is then mixed with a food grade alkaline composition to form a mixture having a pH of from about 6.5 to about 9.5. In this aspect, the step of mixing the comminuted animal muscle tissue with the food grade alkaline composition comprises additional comminution to further reduce particle size of in one or more further comminution steps to form a comminuted meat emulsion having a pH of from about 6.5 to about 9.5.

In an aspect, the comminuted animal muscle tissue is comminuted to the desired end particle size in one or more comminution steps before being mixed with the food grade alkaline composition. The comminuted animal muscle tissue is then mixed with the food grade alkaline composition to form a comminuted meat emulsion having a pH of from about 6.5 to about 9.5.

In an aspect, the first animal muscle tissue is comminuted in one or more intermediate comminution steps to form a comminuted animal muscle tissue having an average particle size of from about 1 to about 10 mm in the longest dimension, or from about 1 to about 2 mm in the longest dimension.

In an aspect, the particles of the comminuted meat emulsion have an average particle size of less than about 0.1 mm. In an aspect, the particles of the comminuted meat emulsion have an average particle size of from about 0.1 to about 0.4 mm. In an aspect, the particles of the comminuted meat emulsion have a maximum particle size of less than about 1 mm, or less than about 0.5 mm. In an aspect, the comminuted animal muscle tissue is substantially free of particles of larger than 1 mm.

In an aspect, the food grade alkaline composition is an alkaline composition comprising one or more alkaline materials selected from sodium hydroxide, potassium hydroxide, sodium bicarbonate, potassium bicarbonate, or mixtures thereof or the like. In an aspect, the food grade alkaline composition is an alkaline composition consisting of sodium bicarbonate or potassium bicarbonate or mixtures thereof. In an aspect, the food grade alkaline composition is an alkaline composition consisting of sodium bicarbonate. In an aspect, the food grade alkaline composition is an alkaline composition consisting of potassium bicarbonate. In an aspect, the food grade alkaline composition is an alkaline composition consisting of calcium bicarbonate. In an aspect, the food grade alkaline composition is a carbonate, bicarbonate, or a hydroxide composition comprising counterions selected from the group consisting of sodium, potassium, calcium, magnesium or mixtures thereof. The alkaline composition may be provided in solution or in dry form.

In an aspect, the comminuted meat emulsion has a pH of from about 6.5 to about 9.5 prior to being added to the animal muscle portion. In an aspect, the comminuted meat emulsion has a pH of from about 7 to about 9 prior to being added to the animal muscle portion. In an aspect, the comminuted meat emulsion has a pH of from about 7.5 to about 8.5 prior to being added to the animal muscle portion.

In an aspect, the comminuted meat emulsion has a table salt content of from about 1% wt to about 10% wt prior to being added to the animal muscle portion. In an aspect, the comminuted meat emulsion has a table salt content of from about 2% wt to about 6% wt, or from about 3% wt to about 5% wt, prior to being added to the animal muscle portion. In an aspect, the comminuted meat emulsion has an ionic strength of from about 0.2M to about 4M prior to being added to the animal muscle portion. In an aspect, the comminuted meat emulsion has an ionic strength of from about 1M to about 3M prior to being added to the animal muscle portion. For purposes of the present invention, a table salt is a salt selected from sodium chloride, potassium chloride and magnesium chloride and mixtures thereof. The table salt may be provided as purified salt, or may be provided in a technically impure form such as a sea salt or other natural sourced salt. In an aspect, the salt is an iodized salt. It has been found that comminuted meat emulsions comprising table salt are particularly advantageous because salt helps to solubilize and functionalize in particular the myofibrillar proteins of the muscle, and thereby increases water holding capacity and binding property in a manner that additionally provides organoleptic benefit.

Careful control of the pH and ionic strength of the comminuted meat emulsion in all phases of the present method provides excellent properties in the final meat product. Such control has been found to promote solubility of the protein of the first animal muscle tissue in the comminuted meat emulsion. In an aspect, at least about 40%, 50%, 60%, 70%; 75%, 80%, 85% or 90% by weight of the protein of the first animal muscle tissue in the comminuted meat emulsion is solubilized, and the protein of the first animal muscle tissue in the comminuted meat emulsion is not isolated from the first animal muscle tissue in the comminuted meat emulsion. The provision of very high percentage of solubilized protein in the comminuted meat emulsion has been found to provide superior water retention properties. While not being bound by theory, it is believed that soluble proteins have great affinity for water while at the same time exhibiting affinity to the protein in the animal muscle portion to be treated, and even to fat in the emulsion and or animal muscle portion. In an aspect, from about 75% to about 98% by weight of the protein of the first animal muscle tissue in the comminuted meat emulsion is solubilized. In an aspect, from about 80% to about 95% by weight of the protein of the first animal muscle tissue in the comminuted meat emulsion is solubilized. In an aspect, no more than about 30%, 25%, 20%, 15% or 10% by weight of the protein of the first animal muscle tissue in the comminuted meat emulsion is precipitated. In an aspect, from about 30% to about 2% by weight of the protein of the first animal muscle tissue in the comminuted meat emulsion is precipitated. In an aspect, from about 25% to about 5% by weight of the protein of the first animal muscle tissue in the comminuted meat emulsion is precipitated. While not being bound by theory, it is believed that precipitated protein self-isolates from water, other proteins, fats and other ingredients in the emulsion and/or animal muscle portion to be treated. This self-isolation is believed to limit interaction of the precipitated protein with the other ingredients, providing lower product benefit as compared to solubilized proteins.

In an aspect, the comminuted meat emulsion may be sodium-free, (i.e., the comminuted meat emulsion has a sodium content at or less than about 1 ppm). In further aspects, the comminuted meat emulsion may comprise phosphate, for example in the form of sodium phosphate. In further aspects, comminuted meat emulsion may be phosphate-free (i.e., the comminuted meat emulsion has a phosphate content at or less than about 1 ppm).

In an aspect, the comminuted meat emulsion has a fat content of less than 60% by weight, 40% by weight, 30% by weight, 20% by weight, or less than 15% or less than 10% or less than 5% by weight.

In an aspect, the comminuted meat emulsion is substantially free of proteins from a source other than the type of meat that is to be enhanced. This aspect is advantageous in that the enhanced muscle portion does not contain enzymes that do not naturally occur in the meat of the enhanced muscle portion, which some consumers may find to be objectionable or undesirable.

In an aspect, the comminuted meat emulsion has a yield stress of greater than 1 Pa. In an aspect, the comminuted meat emulsion has a yield stress of from about 1 to about 40 Pa, or from about 1 to about 15 Pa. In an aspect, the comminuted meat emulsion has a Consistency Index of greater than about 0.2 Pa·sⁿ. In an aspect, the comminuted meat emulsion has a Consistency Index of from about 0.2 Pa·sⁿ to about 60 Pa·sⁿ, or from about 0.2 to about 10 Pa·sⁿ. In an aspect, the comminuted meat emulsion is a pseudoplastic fluid. In an aspect, the comminuted meat emulsion has a Flow Behavior Index of less than 1. In an aspect, the comminuted meat emulsion has a Flow Behavior Index of from about 0.1 to about 0.9, or from about 0.2 to about 0.8, or from about 0.5 to about 0.8. Measurements are made using an MCR502 Controlled Stress Rheometer (Anton Paar) with a Concentric Cylinder, 27 mm geometry at a measurement temperature of 7° C. Particles of a size greater than 1 mm are decanted from the emulsion to avoid measurement artifacts. The shear rate is varied from 0.01 to 1000 l/s, and the data collection time is 40 to 10 seconds. 31 data points are collected. Data is analyzed using the Herschel Bulkley Model.

The consistency of the comminuted meat emulsion is advantageous for incorporation of the comminuted meat emulsion in meat portions, because the comminuted meat emulsion is flowable, but has a thick consistency favorable for retention in the meat portion. This consistency is superior to brines and comminuted meat emulsions made using other methods that result in a more watery consistency.

In an aspect, the comminuted meat emulsion has a water to meat ratio of from about 2:1 to about 20:1, or from about 3:1 to about 10:1.

In an aspect, the comminuted meat emulsion may also include a variety of optional additives. Examples of suitable additives may include salts, binders, synthetic antioxidants, natural antioxidants such as rosemary, and antimicrobials (e.g. bacterial and other pathogen inhibitors such as sodium or potassium lactate). In an aspect, the comminuted meat emulsion comprises natural antibacterial agents as defined by the USDA, such as vinegar, lemon juice, sea salt, and blends thereof (such as MOstatin™ LV1Xm an all natural blend of vinegar and lemon juice from World Technology Ingredients in Jefferson, Ga.). The antibacterial agents may also be buffered, such as MOstatin™ V (buffered vinegar), or formulated for low sodium, such as MOstatin™ VLS (low sodium vinegar), both also from World Technology Ingredients in Jefferson, Ga.

In an aspect of the present invention, the comminuted meat emulsion contains starch, which is present in an aspect in an amount up to about 10% by weight. Additionally, flavorings such as beef, pork or similar materials as appropriate to the particular meat product may be included. Optional flavorants are commercially available from many sources, such as Givaudan SA, Vernier, Switzerland.

The comminuted meat emulsion may be formed by mixing the comminuted animal muscle tissue with a food grade alkaline composition using any appropriate mixing system. It has additionally been found that the ingredients for forming the comminuted meat emulsion may be added in any order. For example, the ingredients of the brine can first be mixed together followed by addition of the comminuted meat. Alternatively, the comminuted meat may be provided, and the other ingredients of the comminuted meat emulsion may be added singly or in combination in any order.

The comminuted meat emulsion is added to the animal muscle portion in a manner that promotes uptake and/or distribution of the comminuted meat emulsion into the animal muscle portion.

In an aspect, the comminuted meat emulsion is injected into an animal muscle portion using any suitable injection equipment, including but not limited to equipment manufactured by Wolf-Tech, Kingston, N.Y. This equipment generally draws the comminuted meat emulsion from a tank and delivers it using pressure through needles to the animal muscle portion. An example of a commercially available brine injector/pump is the Schroder IMAX 630 available from Wolf-Tech, Kingston, N.Y. Another example of an injector system is the Stork/Townsend 1400 injector. The injector equipment is selected sot that the comminuted meat emulsion can pass through the injection needles without physically plugging the equipment.

In an aspect, the animal muscle portion is physically manipulated in a manner that causes uptake of the comminuted meat emulsion into the animal muscle portion. In an aspect, this mixing is carried out by causing the animal muscle portion to be tumbled, kneaded, massaged or otherwise manipulated in the presence of the comminuted meat emulsion to cause uptake of the comminuted meat emulsion into the animal muscle portion.

In an aspect, the animal muscle portion is vacuum tumbled in the presence of the comminuted meat emulsion at a vacuum of from about 100 Torr to about 20 Torr and for a time of from about 5 to about 60 minutes, or of from about 10 to about 40 minutes, of from about 10 to about 30 minutes. Vacuum tumbling advantageously promotes rapid uptake of comminuted meat emulsion into the animal muscle portion, and preferably improves the overall distribution of the comminuted meat emulsion in the animal muscle portion. Vacuum tumblers are commercially available, such as from Koch Equipment of Kansas City, Mo., or Horizon Bradco of Schenectady, N.Y.

In an aspect, the comminuted meat emulsion is injected into an animal muscle portion using any suitable injection equipment, followed by physical manipulation of the animal muscle portion in a manner that promotes uptake and/or distribution of the comminuted meat emulsion into the animal muscle portion. The physical manipulation is in an aspect carried out by causing the animal muscle portion to be tumbled, kneaded, massaged or otherwise manipulated, optionally under vacuum as discussed above.

In an aspect, the enhanced muscle portion comprises from about 5% to about 50% by weight of comminuted meat emulsion. In an aspect, the enhanced muscle portion comprises from about 5% to about 25% by weight of comminuted meat emulsion. In an aspect, the enhanced muscle portion comprises from about 25% to about 50% by weight of comminuted meat emulsion.

Additional meat processing procedures, such as using carbon monoxide (CO) as a process aid, for example, to ameliorate the loss of the red color of beef, may be incorporated in the present process as appropriate.

In an aspect, the enhanced meat product is substantially free of non-endogenous enzymes. This aspect is advantageous in that the enhanced meat product does not contain enzymes that do not naturally occur in the meat of the enhanced meat product, which some consumers may find to be objectionable or undesirable.

As described above, the comminuted meat emulsion is maintained at a temperature that is at or below about 40° F. throughout the present process. This temperature control has been found to promote the stability of the emulsion.

In an aspect, the comminuted animal muscle tissue has a pH of no less than about 5.3 throughout the present process. In an aspect, the comminuted animal muscle tissue has a pH of no less than about 5.6, or no less than about 5.8, or no less than about 6.0 throughout the present process.

In an aspect of the present invention, a comminuted meat emulsion as described above is prepared as an intermediate product, ready for adding to an animal muscle portion at a later time or in a separate manufacturing facility.

The present process is superior to processes wherein meat is treated with protein that has been solubilized and isolated from a meat source. The present process is easy to carry out and requires no expensive separation steps. The present process also does not require the use of extreme acidic or basic conditions that would be required to isolate protein from a meat source.

The present process is superior to processes wherein meat is treated with protein that has been precipitated from a meat source. The present process is easy to carry out and requires no expensive separation steps. The present process also does not require the use of extreme acidic or basic conditions that would be required to precipitate protein from a meat source.

The present process is superior to processes wherein the comminuted meat emulsion is exposed to an acid treatment that would cause the pH of the meat of the comminuted meat emulsion to be less than about 5.3 either before or after alkali treatment. In one aspect, the present process avoids acid-base reactions that cause release of carbon dioxide or other material that lead to foam generation. The release of carbon dioxide is particularly disadvantageous after addition of the comminuted meat emulsion to the animal muscle portion, because the evolved gas escapes through the meat portion, leaving behind visible pinholes or structurally compromised meat portion products. In another aspect, the present process avoids exposure of acids to proteins that can lead to precipitation of proteins from the comminuted meat emulsion. While not being bound by theory, it is believed that treatment of the comminuted animal muscle tissue only with an alkaline pH composition provides the meat proteins with net charge functionality that promotes interaction with water and/or proteins in the animal muscle portion to be treated, thereby increasing the affinity of the comminuted meat emulsion with the animal muscle portion and/or water. This increased affinity leads to high yields and superior retention of the comminuted meat emulsion in the animal muscle portion. This high yield was surprisingly achieved even though the comminuted animal muscle tissue was not exposed to acidic conditions having a less than about 53.

In an aspect, the comminuted meat emulsion provides superior moisture retention properties in the enhanced muscle portion. Moisture retention is particularly advantageous in meat products that are held at a serving temperature for a time (such as 5-20 minutes) after cooking and prior to consumption.

In an aspect of the present invention, an enhanced muscle portion prepared by the processes as described herein is provided as a wholesale or retail product. In an aspect, one or more enhanced muscle portions are packaged for bulk sale in the wholesale market or for institutional sale.

In an aspect, the packaging format suitable for distribution is an airtight package suitable for storage, transport and presentation to the consumer. The packaging may be of a bulk, shipping, or individual serving type; wherein the container is a formable pouch, injectable pouch, sealable pouch, formable tray, vacuum formable tray or pouch, heat formable tray or pouch, or film covered tray.

The thus provided packaged, enhanced muscle portion may be distributed to retail markets, and food service markets including restaurant, school, hospital, and like markets, in uncooked form. In an aspect, the enhanced muscle portion may be distributed to retail markets, and/or to food service markets including restaurant, school, hospital and like markets, in precooked/ready-to-eat form. In an aspect, the enhanced muscle portion may be distributed to retail markets, and/or to food service markets including restaurant, school, hospital, and like markets, in precooked/ready-to-heat-and-eat form.

### Examples

Representative aspects of the present invention will now be described with reference to the following examples that illustrate the principles and practice of the present invention.

### Example 1: Chicken Breast Portions

A. Carbonate Solution Made with Na₂CO₃

6.25% Na₂CO₃ solution was prepared by dissolving 6.25% Na₂CO₃ powder in water (stirred while adding Na₂CO₃) in the following amounts:

Na₂CO₃ (lbs.) 0.375

### Water 4.625

### Ice 1.000

The pH of the resulting composition was measured and found to be 11.18.

### B. Making Emulsion

Four different emulsion systems were prepared using the following formulations:

TABLE 1

| | | Test Compositions 1, 2 |
|---|---|---|
| Ingredient Formula | Control A | and 3 |
| Water | 2.002 | 2.012 |
| comminuted meat | 0.317 | 0.317 |
| Citric acid | 0.009 | 0 |
| Na₂CO₃ solution | 0.302 | 0.302 |
| LVIX¹ | 0.379 | 0.379 |
| Salt | 0.179 | 0.179 |
| Dextrose | 0.241 | 0.241 |
| Turkey Broth | 0.069 | 0.069 |
| Total (lbs) | 3.5 | 3.5 |

¹MOstatin ™ LVIX, a vinegar lemon juice concentrate natural antibacterial composition from World Technology Ingredients in Jefferson, GA

The Emulsion systems were prepared as follows:

Control A

a) Chicken meat was ground through a ⅛ in plate.
b) Chilled water and ground meat were added to a table top emulsifier (Vitamix™ kitchen blender) having separate chopping and emulsification functionality. The ground meat was chopped for 48 seconds and then emulsified for 24 seconds.
c) pH was determined to be of 3.96.
d) more citric acid added and composition chopped for one minute as necessary to reach a pH of 184.
e) LV1X was added and the composition was chopped for 24 seconds and emulsified for 6 seconds. pH was determined to be 5.5.
f) Na₂CO₃ added as necessary to reach a pH of 6.16
g) Salt, dextrose and turkey broth was added, and the composition was chopped for 48 seconds.
h) pH was checked, and more Na₂CO₃ added as necessary to reach a pH of 7.57
i) the composition was emulsified for 48 seconds, the final pH was checked, and refractometer and temperature measurements were taken. (pH=7.59; refractometer=19.7; temperature 46.4° F.)

Test Composition 1

a) Chicken meat was ground through a ⅛ in plate.
b) Chilled water and the ground meat were added to a Vitamix™ kitchen blender having separate chopping and emulsification functionality. The ground meat was chopped for 48 seconds and then emulsified for 24 seconds.
c) pH was determined to be 5.96.
d) LV1X was added, and the composition was chopped for 24 seconds and emulsified for 6 seconds. pH was determined to be 5.73.
e) Na₂CO₃ added as necessary to reach a pH of 6.79
f) Salt, dextrose and turkey broth was added, and the composition was chopped for 48 seconds.
g) pH was checked, and more Na₂CO₃ added as necessary to reach a pH of 7.55
h) The composition was emulsified for 48 seconds, the final pH was checked, and refractometer and temperature measurements were taken. (pH=7.76; refractometer=19.7; temperature=39.7° F.)
i) Additional water was added to provide an emulsion composition having the same volume as Control A.

Test Composition 2

a) Chicken meat was ground through a ⅛ in plate.
b) Chilled water and the ground meat was added to a Vitamix™ kitchen blender having separate chopping and emulsification functionality. The ground meat was chopped for 48 seconds and then emulsified for 24 seconds.
c) pH was determined to be of 5.96.
d) LV1X was added, and the composition was chopped for 24 seconds and emulsified for 6 seconds. pH was determined to be of 5.69.
e) Na₂CO₃ added as necessary to reach a pH of 6.79
f) Salt, dextrose and turkey broth was added, and the composition was chopped for 48 seconds.
g) pH was checked, and more Na₂CO₃ added as necessary to reach a pH of 7.55
h) the composition was emulsified for 48 seconds, the final pH was checked, and refractometer and temperature measurements were taken. (pH=7.59; refractometer=19.7; temperature=48.4° F.)
i) Additional water was added to provide an emulsion composition having the same volume as Control A.

Test Composition 3

a) Chicken meat was ground through a ⅛ in plate.
b) Chilled water, the ground meat and salt was added to a Vitamix™ kitchen blender having separate chopping and emulsification functionality.
c) pH was determined to be 5.61.
d) LV1X was added, and the composition was chopped for 24 seconds and emulsified for 6 seconds. pH was determined to be 5.27.
e) Na₂CO₃ added as necessary to reach a pH of 6.46
f) Salt, dextrose and turkey broth was added and the composition was chopped for 48 seconds.
g) pH was checked, and more Na₂CO₃ added as necessary to reach a pH of 7.86
h) the composition was emulsified for 48 seconds, the final pH was checked, and refractometer and temperature measurements were taken. (pH=7.86; refractometer=19.7; temperature=47.1° F.)
i) Additional water was added to provide an emulsion composition having the same volume as Control A.

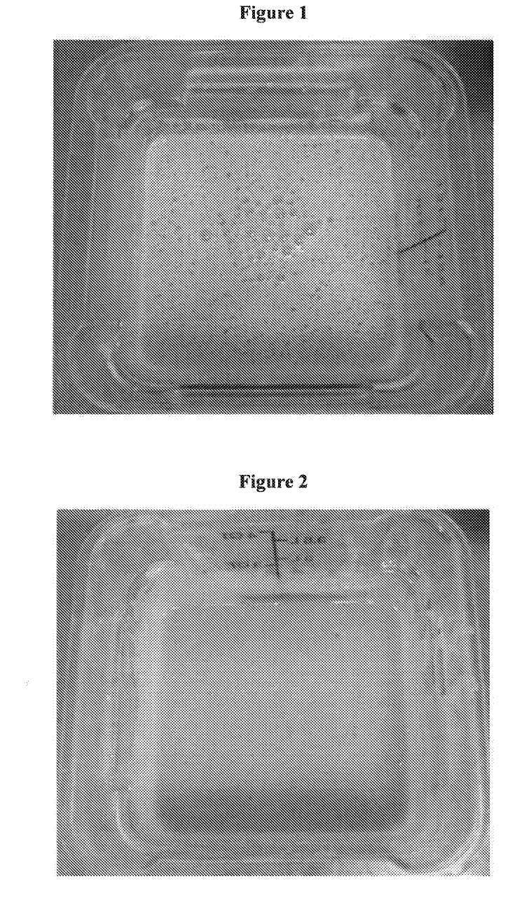

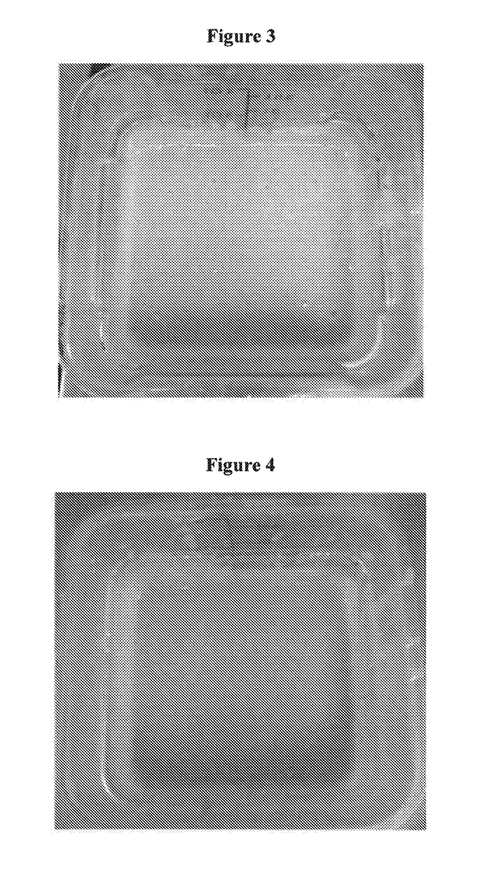

The Test compositions are shown in the figures as follows: Control A—FIG. 1; Test Composition 1, FIG. 2; Test Composition 2, FIG. 3; Test Composition 3, FIG. 4.

As can be seen, the control composition has a bubbled appearance caused by evolution of CO₂ gas from the acid base reaction. Test Compositions 1-3 do not exhibit bubbling.

### C. Injecting Meat

Emulsions were stored in closed-lid plastic containers at less than 40° F. until injection. Four whole chicken breast halves were allotted for each treatment. Each chicken breast was injected to a 134% (by wt.) pump rate and they were tumbled in a tabletop tumbler for 30 minutes. After tumbling, each breast piece was weighed before and after packaging by vacuum-packaging. All treated chicken breasts were cooked together to an internal temperature of 165° F. in the steam oven and chilled in an ice-water bath for 30 min. After 6 hours of cold storage at less than 40° F., each breast piece was weighed before and after removal from the vacuum-bag package.

### D. Yield Data

Yield percentages (tumbled and cooked) were calculated as follows for each breast piece after tumbling, and cooking.

% Tumbled yield=(meat wt. after tumbling/meat wt. after injecting)×100

% Cooked yield (tumbled wt. basis)=(meat wt. after cooking/meat wt. after tumbling)×100%

% Cooked yield (pumped wt. basis)=(meat wt. after cooking/meat wt. after injecting)×100

The results are reported in Table 2:

TABLE 2
Weights and Calculated Yield Percentages

| | | | | | | | | | % Cooked Yield | |
|---|---|---|---|---|---|---|---|---|---|---|
| | | | | | Wt. after | | Meat | | Based | |
| | | | Wt. after | Wt. | cooking | | Wt. | % | on | Based on |
| | Green | Pump | 30 min | after | (removed | Bag | after | Tumbled | Pump | Tumbled |
| Trt | Wt. | Wt. | tumbling | bagging | from bag) | Wt. | cooking | Yield | Wt. | wt. |
| Control | 0.428 | 0.574 | 0.564 | 0.570 | 0.570 | 0.006 | 0.474 | 98.26 | 82.58 | 84.04 |
| Control A | 0.528 | 0.708 | 0.658 | 0.662 | 0.662 | 0.004 | 0.568 | 92.94 | 80.23 | 86.32 |
| Control A | 0.58 | 0.777 | 0.742 | 0.746 | 0.746 | 0.004 | 0.65 | 95.50 | 83.66 | 87.60 |
| Control A | 0.67 | 0.898 | 0.852 | 0.854 | 0.854 | 0.002 | 0.762 | 94.88 | 84.86 | 89.44 |
| Test 1 | 0.444 | 0.595 | 0.592 | 0.596 | 0.596 | 0.004 | 0.506 | 99.50 | 85.04 | 85.47 |
| Test 1 | 0.626 | 0.839 | 0.798 | 0.804 | 0.804 | 0.006 | 0.704 | 95.11 | 83.91 | 88.22 |
| Test 1 | 0.444 | 0.595 | 0.58 | 0.584 | 0.584 | 0.004 | 0.484 | 97.48 | 81.34 | 83.45 |
| Test 1 | 0.722 | 0.967 | 0.912 | 0.914 | 0.914 | 0.002 | 0.792 | 94.31 | 81.90 | 86.84 |
| Test 2 | 0.504 | 0.675 | 0.658 | 0.660 | 0.660 | 0.002 | 0.554 | 97.48 | 82.07 | 84.19 |
| Test 2 | 0.546 | 0.732 | 0.672 | 0.676 | 0.676 | 0.004 | 0.582 | 91.80 | 79.51 | 86.61 |
| Test 2 | 0.572 | 0.766 | 0.732 | 0.734 | 0.734 | 0.002 | 0.63 | 95.56 | 82.25 | 86.07 |
| Test 2 | 0.454 | 0.608 | 0.582 | 0.584 | 0.584 | 0.002 | 0.494 | 95.72 | 81.25 | 84.88 |
| Test 3 | 0.558 | 0.748 | 0.722 | 0.724 | 0.724 | 0.002 | 0.586 | 96.52 | 78.34 | 81.16 |
| Test 3 | 0.464 | 0.622 | 0.598 | 0.600 | 0.600 | 0.002 | 0.518 | 96.14 | 83.28 | 86.62 |
| Test 3 | 0.498 | 0.667 | 0.628 | 0.632 | 0.632 | 0.004 | 0.54 | 94.15 | 80.96 | 85.99 |
| Test 3 | 0.474 | 0.635 | 0.598 | 0.600 | 0.600 | 0.002 | 0.488 | 94.17 | 76.85 | 81.61 |

Data were statistically analyzed using SAS JMP 11 as a one-way ANOVA with individual breast piece used as the experimental unit. Separation of means was conducted using LSMeans Tukey HSD test option at P<0.05 (Table 3).

The results are reported in Table 3:

TABLE 3
Least square means

| | Treatment | | | | |
|---|---|---|---|---|---|
| | Control A | Test 1 | Test 2 | Test 3 | P-value |
| % Tumbled Yield | 95.40 | 96.60 | 95.14 | 95.24 | 0.7448 |
| % Cooked Yield | 86.85 | 86.00 | 85.44 | 83.84 | 0.2982 |
| (based on meat wt. | | | | | |
| after tumbling) | | | | | |
| % Cooked Yield | 82.83 | 83.05 | 81.27 | 79.86 | 0.1468 |
| (based on meat wt. | | | | | |
| after pumping) | | | | | |

There was no significant difference in % tumbled yield among treatments (P=0.7448). Also, there was no significant difference in % cooked yields (based on either tumbled or pumped wt.) among treatments (P=0.2982, and P=0.1468, respectively).

### E. Conclusion

Comminuted meat emulsions either made by directly raising pH or by first lowering and then raising pH generally have the same % tumbled and cooked yield improvements. The present process, wherein the comminuted meat emulsion has a pH of no less than about 5.3 throughout the process, is both simpler and requires less use of alkaline materials than a process comprising first acid treatment and then neutralization and alkaline treatment. Additionally, the present process uses a smaller number of ingredients in the process because acid is not used. This is a direct advantage for the manufacturer because of reduced raw material costs, and also provides substantial perceived consumer benefit, because few materials are listed on the product label.

### Example 2: Ham Log Portions

A. Carbonate Solution Made with Na₂CO₃

6.25% Na₂CO₃ solution was prepared by dissolving 6.25% Na₂CO₃ powder in water (stirred while adding Na₂CO₃) in the following amounts:

Na₂CO₃ (lbs.) 9.375

### Water 140.625

The total amount of the Na₂CO₃ composition prepared was 160 lbs., and the pH of the resulting composition was 11.42.

### B. Making Emulsion

Three different emulsion systems were prepared using the following formulations:

TABLE 4
Ingredient formula

| | 500 lb. Brine | | |
|---|---|---|---|
| | Control B | Control C | Test 4 |
| Water | 278.045 | 198.43 | 199.36 |
| (pH 7.57/T°−67.8° F.) | | | |
| Ice | 0 | 49.60 | 49.84 |
| Comminuted | 0 | 44.99 | 44.99 |
| Citric acid | 0 | 1.17 | 0 |
| Carbonate sol. | 0 | 43.23 | 43.23 |
| Water + Ice | 0 | 40.53 | 40.53 |
| sodium carbonate | 0 | 2.70 | 2.70 |
| Sea salt | 51.617 | 37.81 | 37.81 |
| Demerara Sugar | 49.897 | 36.55 | 36.55 |
| Pork stock P5505¹ | 17.206 | 12.60 | 12.60 |
| Veg Stable ® cherry | 10.323 | 7.56 | 7.56 |
| 515² | | | |
| Veg Stable ® 504³ | 13.765 | 10.08 | 10.08 |
| MOstatin ™ VLS⁴ (pH | 77.426 | 56.72 | 56.72 |
| 6.68/T°−38.7° F.) | | | |
| Rosemary Extract 09⁵ | 1.721 | 1.26 | 1.26 |
| Total brine (lb.) | 500.00 | 500.00 | 500.00 |

¹dehydrated pork stock from Proliant ®
²Veg Stable ® cherry 515 from Florida Food Products, Inc.
³Veg Stable ® 504 Celery Juice Powder from Florida Food Products, Inc.
⁴MOstatin ™ VLS—vinegar low sodium
⁵Guardian ™ Rosemary Extract 09 from Danisco USA

The Emulsion systems were prepared as follows:

Control B

a) Water was added to vessel and pH was determined to be 8.54.
b) Ingredients were added to an InjectStar emulsifier having separate chopping and emulsification functionality, and chopped for 2 minutes.
c) the composition was emulsified for 2 minutes, the final pH was checked, and refractometer and temperature measurements were taken. (pH=5.29; refractometer=34.2; temperature=46.2° F.)

Control C

a) Ham meat was ground through a ⅛ in plate.
b) Chilled water, ground meat and citric acid were added to an InjectStar emulsifier having separate chopping and emulsification functionality. The ground meat was chopped for two minutes and then emulsified for one minute.
c) pH was determined to be 3.72.
d) MOstatin™ VLS was added, and the composition was chopped for one minute and emulsified for 15 seconds. pH was determined to be 5.52.
e) Na₂CO₃ added as necessary to reach a pH of 7.51.
f) Sea salt, demerara sugar, pork stock P5505, Veg Stable® cherry 515, Veg Stable® 504, and Guardian™ Rosemary Extract 09 was added, and the composition was chopped for two minutes.
g) pH was checked, and more Na₂CO₃ added as necessary to reach a pH of 7.48
h) the composition was emulsified for 2 minutes, the final pH was checked, and refractometer and temperature measurements were taken. (pH=7.48; refractometer=22.8; temperature=51.8° F.)

Test Composition 4

a) Ham meat was ground through a ⅛ in plate.
b) Chilled water, and ground meat was added to an InjectStar emulsifier having separate chopping and emulsification functionality. The ground meat was chopped for two minutes and then emulsified for one minute.
c) pH was determined to be 6.07.
d) MOstatin™ VLS was added, and the composition was chopped for one minute and emulsified for 15 seconds. pH was determined to be 5.87.
e) Na₂CO₃ added as necessary to reach a pH of 7.49.
f) Sea salt, demerara sugar, pork stock P5505, Veg Stable® cherry 515, Veg Stable® 504, and Guardian™ Rosemary Extract 09 was added, and the composition was chopped for two minutes.
g) pH was checked, and more Na₂CO₃ added as necessary to reach a pH of 7.51
h) the composition was emulsified for 2 minutes, the final pH was checked, and refractometer and temperature measurements were taken, (pH=7.51; refractometer=23.4; temperature=50.1° F.)

### C. Injecting, Maceration, & Tumbling

Whole, deboned ham muscles were injected (C—19.25%, T1—28.02%, T2—28.02%), and a plurality grooves were cut into the muscles to a depth of about one inch to provide increased surface area to facilitate uptake of emulsion in the meat. The ham muscles were put in the tumbler together with any emulsion exuded from the muscle after injection, vacuum tumbled for 45 min. Additional ham meat was ground through a ⅛ inch plate and added as a binder as described in Table 5 to the tumbler and vacuum tumbled for 15 minutes more. Tumbled muscles were kept for about 18 hours before stuffing the next day. Muscles were stuffed in WorldPac™ 150 mm Sun Smoke casings to form a log. Logs were clipped and massaged to a “D-shape” cross-section.

### D. Cooking and Slicing

The logs were cooked together to an internal temperature of 162° F. in the steam oven at 100% humidity and chilled in a chill house to a temperature of 34° F. Two logs of each were sliced to thicknesses of 1.1-1.3 mm.

### E. Yield Data

All the logs were weighed (before and after removal from the casing) to calculate yields after removal from the casing. The results are reported in Tables 5, 6 and 7:

TABLE 5
Injection, Maceration & Tumbling

| | Control B | Control C | Test 4 |
|---|---|---|---|
| 4pc ham muscle (lb.) | 40.20 | 35.40 | 46.40 |
| Weight of brine injected (lb.) | 7.74 | 9.92 | 9.92 |
| | (19.25% | (28.02% | (28.02% |
| | rate) | rate) | rate) |
| Weight of GMA added (lb.) | 5.33 | 4.69 | 4.69 |
| Total weight supposed to be (lb.) | 53.27 | 50.00 | 50.00 |
| Meat weight supposed to be after | 47.94 | 45.32 | 45.32 |
| injection (lb.) | | | |
| Meat weight after injection (lb.) | 47.95 | 45.24 | 44.36 |
| Meat weight after maceration (lb.) | 47.75 | 44.44 | 42.46 |
| Brine add back (lb.) | 0.19 | 0.88 | 2.86 |
| Meat weight after tumbling (lb.) | 53.04 | 49.72 | 49.24 |
| Meat pH after tumbling | 5.71 | 6.04 | 6.07 |
| # of logs stuffed and their total | 5/47.85 lb. | 4/40.10 lb. | 4/45.20 lb. |
| weights | | | |

TABLE 6
Calculated striped yield percentages

| | Log + | | | | Avg. % |
|---|---|---|---|---|---|
| | Bag + Purge | Bag | Meat | Casingless | Casingless |
| TRT | Wt. | Wt. | Wt. | % Yield | Yield ± SD |
| Control B | 9.356 | 0.208 | 7.402 | 80.91 | 82.59 ± 2.37^{B} |
| Control B | 9.400 | 0.262 | 7.512 | 82.21 | |
| Control B | 9.40 | 0.15 | 7.45 | 80.54 | |
| Control B | 9.40 | 0.15 | 8.00 | 86.49 | |
| Control B | 9.75 | 0.15 | 7.95 | 82.81 | |
| Control C | 9.758 | 0.278 | 8.500 | 89.66 | 90.29 ± 2.44^{A} |
| Control C | 10.49 | 0.208 | 9.700 | 92.47 | |
| Control C | 10.25 | 0.15 | 8.80 | 87.13 | |
| Control C | 10.05 | 0.15 | 9.10 | 91.92 | |
| Test 4 | 11.176 | 0.142 | 9.852 | 89.29 | 90.54 ± 1.04^{A} |
| Test 4 | 10.992 | 0.142 | 9.880 | 91.06 | |
| Test 4 | 10.35 | 0.20 | 9.15 | 90.15 | |
| Test 4 | 12.80 | 0.20 | 11.55 | 91.67 | |

| | |
|---|---|
| P-Value | 0.0002 |

^{AB}Within a column, means without a common superscript differ at P ≦ 0.05.

TABLE 7
Proximate composition and pH values on cooked items

| | pH | | | | | | | |
|---|---|---|---|---|---|---|---|---|
| | Before | After | | | | % | | Avg. Na+ |
| TRT | cooking | cooking | % Fat | % Protein | % Moisture | Salt | % PFF | (mg/100 g) |
| Control B | 5.71 | 6.02 | 2.5683 | 23.8041 | 69.1430 | 1.6633 | 24.43 | 806.9172 |
| Control C | 6.04 | 5.98 | 1.2164 | 19.4491 | 74.8053 | 2.0802 | 19.69 | 860.3079 |
| Test 4 | 6.07 | 6.03 | 2.7339 | 21.4942 | 71.4179 | 1.8307 | 22.10 | 817.7734 |

Data were statistically analyzed using SAS JMP 11 as a one-way ANOVA with individual log as an experimental unit. Separation of means was conducted using LSMeans Tukey HSD test option at P<0.05 (Table 7).

Percentage casingless yields of Control B (82.59%) was significantly (P=0.0002) lower than Control C and Test 4 (CC—90.29%, T4—90.54%). Since Control C and Test 4 were injected 5% higher than Control B, overall % yield improvement of Control C and Test 4 was ˜13%.

Before cooling, the pH levels of Control C and Test 4 were higher than that of Control B (Table 6; CB—5.71; CC—6.04; T4—6.07); however, after cooking, the difference of pH levels among them were not prominent (Table 6; CB—6.02; CC—5.98; T4—6.03).

The cooked Control B had lower % moisture (Table 6; CB—69.1%) than Control C and Test 4 (CC—74.8%; T4—71.4%). Based on the % Protein Fat Free (“PFF”), all the samples still belonged to the “Cured Ham with natural juices” category as defined by the USDA. (Table 7; % PFF—≧18.5).

### F. Conclusion

Inclusion of either acid-treated comminuted meat emulsion (CC) or non-acid-treated comminuted meat emulsion (T4), show the same yield improvements after cooking. Since both Control C and Test 4 had higher pump (22%) compared to Control B (17%), actual yield improvement of both Control C and Test 4 is 13%.

This example demonstrates the following benefits:

The emulsion prepared in Test 4 did not exhibit bubbling, while the emulsion prepared as Control C had bubbles. Gas evolution generating bubbles by the emulsion adversely affects the appearance and integrity of the final meat product.

Slices of both Control C and Test 4 had following improvements compared to slices of Control B;

Less generation of shavings during slicing.

Easier slicing.

Less purge (generation of exudate) in the casing.

Slices exhibit higher texture integrity/ease of handling of individual slices.

### Example 3: Turkey Log Portions

A. Carbonate Solution Made with Na₂CO₃

6.25% Na₂CO₃ solution was prepared by dissolving 6.25% Na₂CO₃ powder in water (stirred while adding Na₂CO₃) in the following amounts:

Na₂CO₃ (lbs.) 9.375

### Water 140.625

The total amount of the Na₂CO₃ composition prepared was 160 lbs., and the pH of the resulting composition was 11.52.

### B. Making Emulsion

Three different emulsion systems were prepared using the following formulations:

TABLE 3
Ingredient formula

| | 500 lb. Brine | | |
|---|---|---|---|
| | Control D | Control E | Test 5 |
| Water (pH 7.44) | 160.970 | 169.352 | 170.168 |
| Ice | 40.243 | 42.338 | 42.542 |
| Comminuted Meat | 0 | 42.69 | 42.69 |
| Citric acid | 0 | 1.02 | 0 |
| Carbonate sol. | 0 | 43.44 | 43.44 |
| Water + Ice | 0 | 40.725 | 40.725 |
| sodium carbonate | 0 | 2.715 | 2.715 |
| Sea salt | 56.022 | 37.72 | 37.72 |
| Demerara Sugar | 65.359 | 44.0 | 44.0 |
| Savory flavoring G7748¹ | 35.014 | 23.57 | 23.57 |
| Proliant Tky Broth² | 23.343 | 15.72 | 15.72 |
| MOstatin VLS (pH 6.92)³ | 116.713 | 78.58 | 78.58 |
| | 2.334 | 1.57 | 1.57 |
| Total brine (lb.) | 500.00 | 500.00 | 500.00 |

¹Savory flavoring G7748 from Newly Weds Foods.
²turkey stock from Proliant ®
³MOstatin ™ VLS—vinegar low sodium

The Emulsion systems were prepared as follows:

Control D

a) Water was added to vessel and pH was determined to be 8.50.
b) Ingredients were added to an InjectStar emulsifier having separate chopping and emulsification functionality. The ground meat was chopped for 2 minutes.
c) The composition was emulsified for 2 minutes, the final pH was checked, and refractometer and temperature measurements were taken. (pH=5.60; refractometer=39.0; temperature=53.2° F.)

Control E

a) Turkey meat was ground through a ⅛ in plate.
b) Chilled water, ground meat and citric acid were added to an InjectStar emulsifier having separate chopping and emulsification functionality. The ground meat was chopped for two minutes and then emulsified for one minute.
c) pH was determined to be 4.14.
d) MOstatin™ VLS was added, and the composition was chopped for one minute and emulsified for 15 seconds. pH was determined to be 5.70.
e) Na₂CO₃ added as necessary to reach a pH of 7.41.
f) Sea salt, demerara sugar, savory flavoring G7748, and Proliant Tky broth were added, and the composition was chopped for two minutes.
g) pH was checked, and more Na₂CO₃ added as necessary to reach a pH of 7.52
h) the composition was emulsified for 2 minutes, the final pH was checked, and refractometer and temperature measurements were taken. (pH=7.52; refractometer=30.1; temperature=42.4° F.)

Test Composition 5

a) Turkey meat was ground through a ⅛ in plate.
b) Chilled water and ground meat were added to an InjectStar emulsifier having separate chopping and emulsification functionality. The ground meat was chopped for two minutes and then emulsified for one minute.
c) was determined to be 5.85.
d) MOstatin™ VLS was added, and the composition was chopped for one minute and emulsified for 15 seconds. pH was determined to be 5.98.
e) Na₂CO₃ added as necessary to reach a pH of 6.74
f) sea salt, demerara sugar, savory flavoring G7748, Proliant Tky broth were added, and the composition was chopped for two minutes.
g) pH was checked, and more Na₂CO₃ added as necessary to reach a pH of 7.52
h) the composition was emulsified for 2 minutes, the final pH was checked, and refractometer and temperature measurements were taken. (pH=7.52; refractometer=31.4; temperature=12.6° F.)

### C. Blending and Tumbling

Ground turkey breasts (prepared using a “Kidney plate” to obtain meat pieces of about two inches) were added into a vacuum blender. The compositions were added (Control D—13.1%; Control E—20.6%; Test 5—20.6%) and blended for 30 minutes under vacuum. Additional ground turkey meat (ground meat added or “GMA”) was ground through a ⅛ inch plate and added as a binder as described in Table 9 for final 15 minutes of tumbling. Stuffing of the meat into casings was done next day using stiffer into WorldPac™ C320S-2 Caramel color casing (150 mm) to form a log. Logs were clipped and massaged to a “D-shape” cross-section.

### D. Cooking and Slicing

The logs were cooked together to an internal temperature of 165° F. in the steam oven at 100% humidity and chilled in a chill house to a temperature of 34° F. Two logs of each were sliced to thicknesses of 1.1-1.3 mm.

### E. Yield Data

All the logs were weighed (before and after removal of casing) to calculate yields after removal from the casing.

The results are reported in Tables 9, 10 and 11:

TABLE 9
Vacuum Blending & Stuffing

| | Control D | Control E | Test 5 |
|---|---|---|---|
| Turkey Breast (lb.) | 49.07 | 46.22 | 46.22 |
| Weight of brine added (lb.) | 6.43 | 9.54 | 9.54 |
| | (13.1% rate) | (20.6% rate) | (20.6% rate) |
| Weight of GMA added (lb.) | 4.50 | 4.24 | 4.24 |
| Total weight (lb.) | 60.00 | 60.00 | 60.00 |
| Meat pH after blending | 5.61 | 6.01 | 6.00 |
| # of logs stuffed and their | 6/57.1 lb. | 5/52.0 lb. | 5/54.6 lb. |
| total weights | | | |

TABLE 10
Calculated Yield Percentages

| | Log + | | | % | Avg. % |
|---|---|---|---|---|---|
| | Bag + Purge | Bag | Meat | Casingless | Casingless |
| TRT | Wt. | Wt. | Wt. | Yield | Yield ± SD |
| Control D | 9.528 | 0.138 | 9.390 | 100.00 | 100.09 ± 0.41 |
| Control D | 9.668 | 0.132 | 9.532 | 99.96 | |
| Control D | 10.15 | 0.15 | 10.00 | 100.00 | |
| Control D | 9.30 | 0.15 | 9.20 | 100.55 | |
| Control D | 8.90 | 0.15 | 8.80 | 100.57 | |
| Control D | 9.70 | 0.15 | 9.50 | 99.48 | |
| Control E | 10.122 | 0.102 | 10.016 | 99.96 | 99.99 ± 0.24 |
| Control E | 10.738 | 0.104 | 10.632 | 99.98 | |
| Control E | 10.35 | 0.10 | 10.25 | 100.00 | |
| Control E | 10.40 | 0.10 | 10.30 | 100.00 | |
| Control E | 10.50 | 0.10 | 10.40 | 100.00 | |
| Test 5 | 11.25 | 0.124 | 11.122 | 99.96 | 100.06 ± 0.02 |
| Test 5 | 11.816 | 0.128 | 11.672 | 99.86 | |
| Test 5 | 10.75 | 0.15 | 10.65 | 100.47 | |
| Test 5 | 10.55 | 0.15 | 10.40 | 100.00 | |

| | |
|---|---|
| P-Value | 0.8321 |

TABLE 11
Proximate composition and pH values on cooked items

| | pH | | | | | | |
|---|---|---|---|---|---|---|---|
| | Before | After | | | | | Avg. Na+ |
| TRT | cooking | cooking | % Fat | % Protein | % Moisture | % Salt | (mg/100 g) |
| Control | 5.61 | 5.86 | 0.7759 | 20.8704 | 74.1066 | 1.7024 | 725.2977 |
| Control E | 6.01 | 5.92 | 1.1790 | 20.5002 | 74.4120 | 1.5277 | 725.3111 |
| Test 5 | 6.00 | 5.83 | 0.9312 | 19.6545 | 75.2199 | 1.7473 | 767.6204 |

Data were statistically analyzed using SAS JMP 11 as a one-way ANOVA with individual log as an experimental unit. Separation of means was conducted using LSMeans Tukey HSD test option at P<0.05 (Table 11).

There is no significant difference in % yields among treatments after the casing has been removed. However, Control E and Test 5 (17%) had higher pump compared to Control D (12%). Therefore, apparent yield improvement is 5% more than Control D.

### F. Conclusion

Inclusion of either acid-treated comminuted meat emulsion (CE) or non-acid-treated comminuted meat emulsion (T5), show the same yield improvements after cooking. Since both Control E and Test 5 had higher pump (22%) compared to Control D (17%), actual yield improvement of both Control E and Test 5 is 13%.

This example demonstrates the following benefits:

The emulsion prepared in Test 5 did not exhibit bubbling, while the emulsion prepared as Control E had bubbles. Gas evolution generating bubbles by the emulsion adversely affects the appearance and integrity of the final meat product.

Slices of both Control E and Test 5 had the following improvements compared to Control D slices:

Less generation of shavings during slicing.

Easier slicing.

Less purge (generation of exudate) in the easing.

Slices exhibit higher texture integrity/ease of handling of individual slices.

### Example 4. Folly Cooked and Smoked Black Forest Ham

| | % Final | % in Brine |
|---|---|---|
| Ingredients | | |
| Pork Ham Insides/Outsides | 68.00 | |
| ⅛″ ground Pork Ham Shank | 8.19 | |
| Brine | | |
| Water | 11.72 | 49.24 |
| Ham Shanks ⅛″ Ground | 3.81 | 16.00 |
| 6.25% Sodium Carbonate Solution | 2.68 | 11.24 |
| Mostatin LV1X (Vinegar, lemon Juice | 1.50 | 6.30 |
| Concentrate) | | |
| Mostatin VLS (Vinegar Low Sodium) | 1.00 | 4.20 |
| Sea Salt | 1.20 | 5.04 |
| Cane Sugar | 1.65 | 6.93 |
| Modern Cure w/Sea Salt | 0.25 | 1.05 |
| | 100.00 | 100.00 |

### A. Brine Preparation:

Water, pork ham shank (⅛″ ground), Mostatin LV1X, Mostatin (VLS), Sea Salt, cane sugar, Modern cure are added to the brine mixing tank, mix together and emulsified (particle reduction). Sodium carbonate (6.25% sodium carbonate in water, w/w basis) is added to the emulsion until the pH of the final brine reaches 6.8-8.0 (target 7.2-7.8).

### B. Injection, Maceration, and Tumbling:

Brine is injected into whole pork ham muscles at 35%. Injected muscles are run through a macerator to get ¾-1″ deep surface cuts. Then, macerated pork ham muscles are added to the tumbler and vacuum-tumbled for 10 min at 20 rpm. Then binder meat (⅛″ ground Pork Ham Shank) is added to the tumbler at 12% based on whole pork ham meat weight and tumbled for another 10 min at 20 rpm. Tumbled meat is held for at least 18 hours for cure before cooking.

### C. Stuffing and Cooking:

Tumbled meat is stuffed into VicoFan caramel color fibrous casings to form ‘D’ shape logs. Both ends of each log are poly-clipped. Logs are cooked and smoked (Hardwood Oak chips) to an internal temperature of 155° F. and chilled.

### D. Slicing and Packing:

Casings are removed from logs before slicing. Logs are sliced into 2.4-2.6 mm thick slices, packaged into 2 lb single-shingle format in modified atmosphere packages (80% N₂ and 20% CO₂) and frozen.

### Example 5. Sliced Smoked Uncured Ham with Natural Juices

| | % Final | % in Brine |
|---|---|---|
| Ingredients | | |
| Pork Ham muscles | 69.390 | |
| ⅛″ ground Pork Ham Shank | 8.743 | |
| Brine | | |
| Water | 8.404 | 38.434 |
| Ham Shanks ⅛″ Ground | 3.499 | 16.000 |
| 9.09% reacted Sodium bicarbonate | 3.936 | 18.000 |
| solution | | |
| Mostatin VLS (Vinegar Low Sodium) | 2.250 | 10.290 |
| Salt | 1.700 | 7.774 |
| Cane Sugar | 1.365 | 6.242 |
| Veg Stable 504 (Celery powder) | 0.400 | 1.829 |
| Veg Cherry 515 | 0.300 | 1.372 |
| Charsol 5105 liquid smoke | 0.013 | 0.059 |
| | 100.00 | 100.00 |

### A. Brine Preparation:

Water, reacted sodium bicarbonate, and Mostatin VLS were added to the brine mixing tank and mixed together. Then, salt, cane sugar, celery powder, cherry powder and liquid smoke were added to the mixing tank, mixed and emulsified (particle reduction). Ground pork shank meat were added to the brine, mixed together and emulsified. pH of the emulsion was between 6.8-8.0 (target 7.2-7.8).

### B. Injection, Maceration, and Tumbling:

Brine was injected into whole pork ham muscles at 31.5%. Injected muscles were run through a macerator to get ¾-1″ deep surface cuts. Then, macerated pork ham muscles were added to the tumbler and vacuum-tumbled for 15 min at 20 rpm. Then, binder meat (⅛″ ground Pork Ham Shank) was added to the tumbler at 12.6% based on whole pork ham meat weight and tumbled for another 15 min at 20 rpm. Tumbled meat was held for at least 18 hours for cure before cooking.

### C. Stuffing and Cooking:

Tumbled meat was stuffed into fibrous casing (Kalle PH6 Prestuck Nalo). Both ends of each log were poly-clipped. Logs were cooked to an internal temperature of 155° F. and chilled.

### B. Slicing and Packing:

Logs were sliced into 1.6 mm thick slices, packaged into 2 lb in modified atmosphere packages (80% N₂ and 20% CO₂) and refrigerated.

### Example 6. Fully Cooked Seasoned Angus Roast Beef

| | % Final | % in Brine |
|---|---|---|
| Ingredients | | |
| Angus Bottom round | 68.906 | |
| Brine | | |
| Water | 19.831 | 63.790 |
| Angus beef trim (75's) | 5.168 | 16.620 |
| 6.25% Sodium carbonate solution | 1.382 | 4.400 |
| Sodium phosphate | 0.300 | 0.960 |
| Potassium Lactate & sodium diacetate | 2.500 | 8.040 |
| (Opti PD4 ultra; antimicrobial) | | |
| Dextrose | 1.000 | 3.220 |
| Salt | 0.600 | 1.930 |
| Roast beef Seasoning (G76319) | 0.113 | 0.360 |
| Garlic Juice | 0.200 | 0.640 |
| | 100.00 | 100.00 |

### A. Brine Preparation:

Water and ground meat were added to mixing tank and mixed well. Sodium phosphate, salt, dextrose, roast beef seasoning, and garlic juice were added to the brine mixing tank and mixed together. Then, the mixture was emulsified (particle reduction). Then, sodium carbonate solution was added to the emulsion and mixed to adjust the pH to 6.8-8.0 (target 7.2-7.8).

### B. Injection and Tumbling:

Brine was injected to beef bottom rounds at 45.1%. Injected muscles were added to the tumbler and vacuum-tumbled for 30 min at 5 rpm. Rub was added and tumbled for 5 min.

### C. Stuffing and Cooking:

Tumbled beef round muscles were vacuum-bagged, sealed and the bags were heat-shrunk. They are cooked to a final internal temperature of 140° F. and then they are chilled.

### D. Post-Cook Processing:

Bags were removed and cooked bottom rounds were cut into halves (deli-faced). Halves were rebagged and vacuum-sealed. Then, the bags were heat-shrunk and refrigerated.

As used herein, the terms “about” or “approximately” mean within an acceptable range for the particular parameter specified as determined by one of ordinary skill in the art, which will depend in part on how the value is measured or determined, e.g., the limitations of the sample preparation and measurement system. Examples of such limitations include preparing the sample in a wet versus a dry environment, different instruments, variations in sample height, and differing requirements in signal-to-noise ratios. For example, “about” can mean greater or lesser than the value or range of values stated by 1/10 of the stated values, but is not intended to limit any value or range of values to only this broader definition. For instance, a concentration value of about 30% means a concentration between 27% and 33%. Each value or range of values preceded by the term “about” is also intended to encompass the aspect of the stated absolute value or range of values. Alternatively, particularly with respect to biological systems or processes, the term can mean within an order of magnitude, preferably within 5-fold, and more preferably within 2-fold, of a value.

Throughout this specification and claims, unless the context requires otherwise, the word “comprise”, and variations such as “comprises” and “comprising”, will be understood to imply the inclusion of a stated integer or step or group of integers or steps but not the exclusion of any other integer or step or group of integer or step. When used herein “consisting of” excludes any element, step, or ingredient not specified in the claim element. When used herein, “consisting essentially of” does not exclude materials or steps that do not materially affect the basic and novel characteristics of the claim. In the present disclosure of various aspects, any of the terms “comprising”, “consisting essentially of” and “consisting of” used in the description of an aspect may be replaced with either of the other two terms.

All patents, patent applications (including provisional applications), and publications cited herein are incorporated by reference as if individually incorporated for all purposes. Unless otherwise indicated, all parts and percentages are by weight and all molecular weights are weight average molecular weights. The foregoing detailed description has been given for clarity of understanding only. No unnecessary limitations are to be understood therefrom. The invention is not limited to the exact details shown and described, for variations obvious to one skilled in the art will be included within the invention defined by the claims.

1. A process for treating an animal muscle portion to form an enhanced muscle portion comprising:
providing a comminuted meat emulsion having a pH of from about 6.5 to about 9.5, the comminuted meat emulsion being prepared from a first animal muscle tissue; and
adding the comminuted meat emulsion to an animal muscle portion in a manner that promotes uptake and/or distribution of the comminuted meat emulsion into the animal muscle portion to form an enhanced muscle portion;
wherein at least about 70% by weight of the protein of the first animal muscle tissue in the comminuted meat emulsion is solubilized, and the protein of the first animal muscle tissue in the comminuted meat emulsion is not isolated from the first animal muscle tissue in the comminuted meat emulsion.

2. A process for treating an animal muscle portion to form an enhanced muscle portion comprising:
providing a comminuted meat emulsion having a pH of from about 6.5 to about 9.5, the comminuted meat emulsion being prepared from a first animal muscle tissue; and
adding the comminuted meat emulsion to an animal muscle portion in a manner that promotes uptake and/or distribution of the comminuted meat emulsion into the animal muscle portion to form an enhanced muscle portion;
wherein no more than about 30% by weight of the protein of the first animal muscle tissue in the comminuted meat emulsion is precipitated.

3. A process for treating an animal muscle portion to form an enhanced muscle portion comprising:
providing a comminuted meat emulsion having a pH of from about 6.5 to about 9.5, the comminuted meat emulsion being prepared from a first animal muscle tissue; and
adding the comminuted meat emulsion to an animal muscle portion in a manner that promotes uptake and/or distribution of the comminuted meat emulsion into the animal muscle portion to form an enhanced muscle portion;
wherein the first animal muscle tissue is not exposed to acid in a manner that would cause the pH of the first animal muscle tissue to be less than about 5.3.

4. The process of claim 1, wherein the comminuted meat emulsion is prepared by
comminuting a first animal muscle tissue to provide a comminuted animal muscle tissue; and
mixing the comminuted animal muscle tissue with a food grade alkaline composition to form a comminuted meat emulsion having a pH of at least about 6.5.

5. The process of claim 4, wherein the comminuted animal muscle tissue has an average particle size of from about 1 to about 2 mm.

6. The process of claim 4, wherein the mixing step further comprises comminution to further reduce particle size of the comminuted animal muscle tissue.

7. The process of claim 1, wherein the comminuted meat emulsion has an average particle size of less than about 0.1 mm.

8. The process of claim 1, wherein the comminuted meat emulsion has an average particle size of from about 0.1 to about 0.4 mm.

9. The process of claim 1, wherein the comminuted meat emulsion has a maximum particle size of less than about 1 mm.

10. The process of claim 1, wherein the comminuted meat emulsion has a pH of
from about 7 to about 9.

11. The process of claim 1, wherein the comminuted meat emulsion has a pH of
from about 7.5 to about 8.5.

12. The process of claim 1, wherein the comminuted meat emulsion has a fat content of less than about 25% by weight.

13. The process of claim 1, wherein the comminuted meat emulsion has a fat content of less than 5% by weight.

14. The process of claim 1, wherein the comminuted meat emulsion comprises myofibrillar protein that is at least about 50 wt % of the protein content of the meat in the comminuted meat emulsion.

15. The process of claim 1, wherein the comminuted meat emulsion comprises myofibrillar protein that is from about 70 wt % to about 90 wt % of the protein content of the meat in the comminuted meat emulsion.

16. The process of claim 1, wherein the myofibrillar protein is at least about 2 wt % of the comminuted meat emulsion.

17. The process of claim 1, wherein the myofibrillar protein is at least about 2.5 wt % of the comminuted meat emulsion.

18. The process of claim 1, wherein the myofibrillar protein is from about 2.5 wt % to about 10 wt % of the comminuted meat emulsion.

19. The process of claim 1, wherein the comminuted meat emulsion has a yield stress of from about 1 to about 15 Pa.

20. The process of claim 1, wherein the comminuted meat emulsion has a Consistency Index of from about from about 0.2 to about 10 Pa·sⁿ.

21. The process of claim 1, wherein the comminuted meat emulsion has a Flow Behavior Index of less than 1.

22. The process of claim 1, wherein the comminuted meat emulsion has a Flow Behavior Index of from about 0.1 to about 0.9.

23. The process of claim 1, wherein the comminuted meat emulsion has a Flow Behavior Index of from about 0.2 to about 0.8.

24. The process of claim 1, wherein the comminuted meat emulsion has a yield stress of from about 10 to about 15 Pa, a Consistency Index of from about 0.2 to about 10 Pa·sⁿ, and a Flow Behavior Index of less than 1.

25. The process of claim 1, wherein the comminuted meat emulsion is added to the animal muscle portion by a process comprising injecting the comminuted meat emulsion into the animal muscle portion.

26. The process of claim 1, wherein the comminuted meat emulsion is added to the animal muscle portion by a process comprising physically manipulating the animal muscle portion in a manner that causes uptake of the comminuted meat emulsion into the animal muscle portion.

27. The process of claim 1, wherein the enhanced muscle portion comprises from about 10% to about 50% by weight of comminuted meat emulsion.

28. The process of claim 4, wherein the food grade alkaline composition is an alkaline composition comprising one or more alkaline materials selected from sodium hydroxide, potassium hydroxide, calcium hydroxide, magnesium hydroxide, sodium bicarbonate, potassium bicarbonate, calcium bicarbonate, magnesium bicarbonate, sodium carbonate, potassium carbonate, calcium carbonate, magnesium carbonate, or mixtures thereof.

29. The process of claim 4, wherein the food grade alkaline composition consists of sodium bicarbonate or potassium bicarbonate, calcium bicarbonate, magnesium bicarbonate, sodium carbonate, potassium carbonate, calcium carbonate, magnesium carbonate, or mixtures thereof.

30. The process of claim 4, wherein the food grade alkaline composition is an alkaline composition consisting of sodium bicarbonate, sodium carbonate or mixtures thereof.

31. The process of claim 4, wherein the food grade alkaline composition is an alkaline composition consisting of potassium bicarbonate, potassium carbonate or mixtures thereof.

32. The process of claim 1, wherein the comminuted meat emulsion is prepared as an intermediate product and is packaged and stored for addition to the animal muscle portion at a later time.

33. The process of claim 1, wherein the comminuted meat emulsion is prepared as an intermediate product and is added to the animal muscle portion in a separate manufacturing facility.

34. An enhanced muscle portion made by the process of claim 1.

35. The process of claim 1, wherein at least about 70%, 75%, 80%, 85% or 90% by weight of the protein of the first animal muscle tissue in the comminuted meat emulsion is solubilized.

36. The process of claim 1, wherein from about 75% to about 98% by weight of the protein of the first animal muscle tissue in the comminuted meat emulsion is solubilized.

37. The process of claim 1, wherein from about 80% to about 95% by weight of the protein of the first animal muscle tissue in the comminuted meat emulsion is solubilized.

38. The process of claim 1, wherein no more than about 30%, 25%, 20%, 15% or 10% by weight of the protein of the first animal muscle tissue in the comminuted meat emulsion is precipitated.

39. The process of claim 1, wherein from about 30% to about 2% by weight of the protein of the first animal muscle tissue in the comminuted meat emulsion is precipitated.

40. The process of claim 1, wherein from about 25% to about 5% by weight of the protein of the first animal muscle tissue in the comminuted meat emulsion is precipitated.
